(19) United States
(12) Patent Application Publication
(10) Pub. No.: US 2026/0228586 A1
(43) Pub. Date: Aug. 6, 2026

(54) QUANTUM COMPUTER AND COMPUTING METHOD USING ELECTRON SHUTTLING

(71) Applicant: Hitachi, Ltd., Tokyo (JP)

(72) Inventors: Tomonori SEKIGUCHI, Tokyo (JP); Takeru UTSUGI, Tokyo (JP); Noriyuki LEE, Tokyo (JP)

(21) Appl. No.: 19/149,952

(22) PCT Filed: Mar. 20, 2023
(86) PCT No.: PCT/JP2023/011026

§ 371 Date: Jul. 22, 2025

(51) Int. Cl. G06N 10/40

(52) U.S. Cl. CPC G06N 10/40

(57) ABSTRACT

A quantum bit array chip and a quantum computer capable of restricting an increase in a parameter table size for storing operation conditions necessary for control while restricting a decrease in computing accuracy due to a characteristic variation in the chip The quantum computer includes a quantum dot array in which quantum dots are two-dimensionally arranged, and the quantum computer performs quantum computing by irradiating the quantum dot array with an electromagnetic wave. The quantum dot array is divided into a computing area for performing the quantum computing and a memory area for shuttling a quantum bit stored in the quantum dot, the quantum computer includes a parameter table in which a control voltage and a control time during the quantum computing in the computing area are stored for each quantum dot, and the quantum bit is controlled in the computing area based on the parameter table.

### TECHNICAL FIELD

The present invention relates to a configuration of a quantum computer and a computing method thereof, and more particularly to a technique effectively applied to a quantum computer using a quantum bit array chip in which quantum bits are arranged in an array and integrated.

### BACKGROUND ART

In recent years, quantum computers have attracted attention. The quantum computer is a computer that performs information processing using properties (phenomenon of quantum mechanics) of “quantum” such as atoms and electrons constituting a substance. Up to now, there has been a limit to miniaturization and high performance of semiconductor devices that have supported the progress of computers, and it has become difficult to significantly improve the performance of classical computers in the related art. The quantum computer is one of attempts to overcome this limit by a new calculation principle or a device. Currently, hardware development has been actively performed for implementing quantum computers, and various types of quantum bits, which are the computing elements at the heart of quantum computers, such as superconducting, ion trap, and silicon types have been proposed.

FIG. 1 illustrates a schematic configuration of a silicon quantum computer 1000. Quantum bits (Qubits) 102, which are quantum computing devices, are arranged in an array and mounted on a quantum bit array chip (QBA) 101 manufactured as a silicon chip. In the QBA 101, quantum bit control for quantum computing and sensing of quantum information of computing results are performed. A cryogenic analog chip (CAC) 103 supplies a quantum operation pattern, an operation timing, a bias voltage, and an RF signal to the QBA 101. The CAC 103 is controlled by a host computer and a digital control chip (CDC) 104 having a bridge function, and receives a computing result performed in the QBA 101.

In order to stably operate the quantum bit (Qubit) 102, the QBA 101 is disposed in a dilution refrigerator DR and operated at an extremely low temperature of about 0.1 K. The CAC 103 for controlling the QBA 101 is disposed in an environment of about 4K in the dilution refrigerator DR. The host computer and the CDC 104 are operated at room temperature.

FIG. 2A is a cross-sectional view of a quantum bit (Qubit) array mounted on the QBA 101. In the QBA 101, a spin S of a single electron confined in a potential barrier PB formed in a silicon channel C of an MOS structure is used as a qubit. FIG. 2A illustrates a state in which electrons are trapped immediately below a quantum dot control gate (XQ) 201 by increasing a voltage of the XQ 201 and decreasing a voltage of an interaction control gate (XJ) 202. That is, the XQ 201 functions as a quantum dot capable of trapping electrons, and a quantum bit (Qubit) is formed by trapping one electron therein.

As illustrated in FIG. 2B, quantum bit (Qubit) computing is controlled by irradiating a high-frequency RF signal. A magnetic field B is applied to the qubit in the array, and a frequency f_{S} of the precession is set to 20.01 GHz for a selected bit and 20 GHz for a non-selected bit. When the entire array is irradiated with an RF signal having a frequency of 20.01 GHz, the spin is rotated only in the selected bit in which the frequency of the precession coincides with the frequency of the RF, and the quantum computing can be executed.

In the quantum bit (Qubit) array, as illustrated in FIG. 3, quantum dots are two-dimensionally arranged in an X direction and a Y direction. A plurality of quantum dot control gate wirings (XQ) 2022 and interaction control gates (XJ) 2021 arranged in the X direction are formed as gate wirings of a first layer of the MOS structure, and a plurality of quantum dot control gate wirings (YQ) 2032 and interaction control gates (YJ) 2031 arranged in the Y direction are formed as gate wirings of a second layer. In FIG. 3, in order to make the structure easy to understand, a portion between the gate wiring of the first layer and a silicon channel C is expanded in a Z direction. By adopting such an array structure, large-scale integration of quantum dots and quantum bits (Qubits) is implemented while restricting an increase in the total number of wirings.

As a technique using such quantum bit (Qubit), for example, a technique described in PTL 1 is disclosed.

### CITATION LIST

### Patent Literature

PTL 1: WO2021/251175

### SUMMARY OF INVENTION

### Technical Problem

A problem in the related art represented by PTL 1 will be specifically described with reference to a circuit diagram of a quantum bit (Qubit) array as illustrated in FIG. 4. In the circuit diagram, an initialization area 402 and a sense area 403 are arranged on both sides of a central computing area 401. In the array, a quantum dot control gate MOS (whose gate is connected to XQ or YQ) and an interaction control gate MOS (whose gate is connected to XJ) are alternately arranged. A silicon channel C of an SOI structure is connected in the X direction and enables movement and interaction of electrons between quantum dots via a transfer gate. Further, an interaction control gate MOS (whose gate is connected to YJ) for connecting the silicon channel C in the Y direction is disposed to enable the movement and interaction of electrons also in the Y direction.

In the computing area 401, 128 MOS used as quantum dots are arranged in 8 rows×16 columns. In the initialization area 402 and the sense area 403, 2 columns and 4 columns of MOS as quantum dots are arranged, respectively. One side of the silicon channel C is commonly connected to a reservoir terminal Nres at an array end portion in both the X direction and the Y direction, and the other side thereof is separated as a DOE/DOS terminal. Although not shown as wiring, the RF signal RFQB is arranged on this array by multilayer wiring.

In this chip, there are spin rotation (Rx) computing around an X-axis and spin rotation (Ry) computing around a Y-axis as computing for one quantum bit (Qubit). In each of these, the direction of a spin holding Qubit quantum information is rotated by 90° around the X-axis and the Y-axis of the Bloch sphere.

As an example of control when performing the Rx/Ry computing, control by a dynamic resonance frequency changing method is illustrated in FIGS. 5A and 5B. FIG. 5B illustrates an example of operation waveforms when a Qubit qd00 in the array circuit diagram shown in FIG. 5A is operated. First, a resonance frequency of spin precession of electron in all Qubits is set to 20 GHz by applying a static magnetic field to the entire chip.

When performing computing, a voltage of V_{L1}-V_{L2} is applied between terminals XJN₁ and XJS₁ and XJN₂ and XJS₂, and a current of 20 uA is applied from XJS₁ to XJN₁ and from XJN₂ to XJS₂. Further, a voltage of V_{L3}-V_{L4} is applied between terminals YJW₀ and YJE₀ and YJW₁ and YJW₁, and a current of 1 mA is applied from YJW₀ to YJE₀ and from YJE₁ to YJW₁. Due to a local magnetic field generated by this current, a resonance frequency f_{qd00} of spin precession of an electron in qd00 increases from 20 GHz in a standby state to 20.01 GHz.

In this state, when the RF signal RFQB of 20.01 GHz is applied to the entire chip for a time of ¼ of a Rabi oscillation period t_{RB}, only an electron spin in qd00 having the coincident resonance frequency can be selectively rotated by 90°. At this time, when a phase of the RF signal is coincident with a phase of the spin precession, the rotation around the X-axis is performed, and when a difference of 90° is provided, the rotation around the Y-axis can be implemented. Finally, after the voltages applied between the terminals XJN₁ and XJS₁, XJN₂ and XJS₂, YJW₀ and YJE₀, and YJW₁ and YJE₁ are inverted and the f_{qd00} is set to 19.99 GHz, the phase change of the spin precession is compensated for by standing by for the same time.

To increase the scale of the quantum computing, it is necessary to expand the size of the quantum bit array on the quantum bit chip and increase the number of quantum bits to be integrated. At this time, the influence of variations in device characteristics due to variations in dimensions and compositions at the time of manufacturing the device and spatial variations in RF signal intensity to be irradiated increases.

As an example, a distance between the quantum bit qd00 and the gate XJN₁ in FIG. 5A may be different from a distance between a quantum bit qd10 and the gate XJN₁. In this case, an optimum value of the current applied to the XJN1 to set the resonance frequencies f_{qd00} and f_{qd10} of the precession of spin of these quantum bits to 20.01 GHz differs from 20 uA.

Further, in the quantum bits spatially separated in the array in FIG. 4, when the RF signal is applied to the entire chip, the received signal intensity may be different. In this case, since the Rabi oscillation period t_{RB} varies depending on the quantum bit, the optimum application time of the RF signal for rotating the spin of the selected quantum bit by 90° varies.

Therefore, an object of the invention is to provide a quantum bit array chip, a quantum computer using the quantum bit array chip, and a computing method using electron shuttling capable of restricting an increase in a parameter table size for storing operation conditions necessary for control while restricting a decrease in computing accuracy due to a characteristic variation in the chip even when increasing the number of quantum bits to be integrated in the quantum bit array chip in which quantum bits are arranged in an array and integrated.

### Solution to Problem

In order to solve the above problems, the invention provides a quantum computer including a quantum dot array in which quantum dots are two-dimensionally arranged, and the quantum computer performs quantum computing by irradiating the quantum dot array with an electromagnetic wave. The quantum dot array is divided into a computing area for performing the quantum computing and a memory area for shuttling a quantum bit stored in the quantum dot, the quantum computer includes a parameter table in which a control voltage and a control time during the quantum computing in the computing area are stored for each quantum dot, and the quantum bit is controlled in the computing area based on the parameter table.

Further, the invention includes the following steps of: (a) rearranging quantum bits in a memory area to make the quantum bits adjacent to each other, and then shuttling the quantum bits to a computing area; and (b) controlling the quantum bits in the computing area based on a parameter table in which a control voltage and a control time during quantum computing in the computing area are stored for each quantum dot.

### Advantageous Effects of Invention

According to the invention, it is possible to implement a quantum bit array chip, a quantum computer using the quantum bit array chip, and a computing method using electron shuttling capable of restricting an increase in a parameter table size for storing operation conditions necessary for control while restricting a decrease in computing accuracy due to a characteristic variation in the chip even when increasing the number of quantum bits to be integrated in the quantum bit array chip in which quantum bits are arranged in an array and integrated.

Accordingly, the performance and accuracy of the quantum bit array chip and the quantum computer using the quantum bit array chip can be improved.

Problems, configurations, and effects other than those described above will be clarified by the following description of embodiments.

### BRIEF DESCRIPTION OF DRAWINGS

FIG. 1 is a diagram illustrating a schematic configuration of a silicon quantum computer.

FIG. 2A is a diagram illustrating a cross-sectional structure of a quantum bit (Qubit) array.

FIG. 2B is a diagram schematically illustrating a quantum computing method by electro-magnetic field irradiation.

FIG. 3 is a diagram illustrating a silicon quantum bit array structure.

FIG. 4 is a circuit diagram of a quantum bit array.

FIG. 5A is an array circuit diagram of a dynamic resonance frequency changing method.

FIG. 5B illustrates operation waveforms of the dynamic resonance frequency changing method.

FIG. 6 is a circuit diagram of a quantum bit array according to Embodiment 1 of the invention.

FIG. 7A is a diagram illustrating a part of a computing area in FIG. 6.

FIG. 7B is a diagram illustrating operation waveforms of quantum dot unit computing control.

FIG. 7C illustrates an example of a parameter table in a control chip.

FIG. 8 is a diagram illustrating computing control by electron shuttling.

FIG. 9A is a circuit diagram illustrating an initialization operation of a quantum bit array.

FIG. 9B is a potential diagram illustrating the initialization operation of the quantum bit array.

FIG. 9C is a diagram illustrating operation waveforms of the initialization operation of the quantum bit array.

FIG. 10A is a circuit diagram illustrating a shuttling operation (control of each column) in the quantum bit array.

FIG. 10B is a potential diagram illustrating a shuttling operation (control of each column) in the quantum bit array.

FIG. 10C is a diagram illustrating operation waveforms of the shuttling operation (control of each column) in the quantum bit array.

FIG. 11A is a diagram illustrating an example of quantum computing by electron shuttling.

FIG. 11B is a diagram illustrating an example of a computing sequence by electron shuttling.

FIG. 12 is a diagram illustrating a method of rearranging the order of quantum bits by electron shuttling.

FIG. 13 is a diagram illustrating a quantum bit array according to Embodiment 2 of the invention.

FIG. 14A is a circuit diagram illustrating a spin charge conversion operation in a sense area.

FIG. 14B is a potential diagram illustrating the spin charge conversion operation in the sense area.

FIG. 14C is a diagram illustrating operation waveforms of the spin charge conversion operation in the sense area.

FIG. 15 is a circuit diagram of the sense area in FIG. 13.

FIG. 16 is a diagram illustrating a quantum bit array according to Embodiment 3 of the invention.

FIG. 17 is a circuit diagram of a sense area and an initialization area in FIG. 16.

FIG. 18A is a circuit diagram illustrating a shuttling operation (array entire mode) in the quantum bit array.

FIG. 18B is a potential diagram illustrating the shuttling operation (array entire mode) in the quantum bit array.

FIG. 18C is a diagram illustrating operation waveforms of the shuttling operation (array entire mode) in the quantum bit array.

FIG. 19 is a diagram illustrating a configuration of a quantum bit array chip (QBA).

FIG. 20 is a diagram illustrating a signal interface between a cryogenic analog control chip (CAC) and a quantum bit array chip (QBA).

FIG. 21 is a diagram illustrating a block configuration of registers and switches of a quantum bit array chip (QBA).

FIG. 22 is a diagram illustrating a first switch matrix connected to a quantum bit array control signal line.

FIG. 23 is a diagram illustrating a second switch matrix connected to the quantum bit array control signal line.

FIG. 24 is a diagram illustrating a third switch matrix connected to the quantum bit array control signal line.

FIG. 25 is a diagram illustrating a slew rate control method for a first array control signal line.

FIG. 26 is a diagram illustrating a slew rate control method for a second array control signal line.

FIG. 27A is a diagram illustrating a cross-sectional structure of a quantum bit (Qubit) array.

FIG. 27B is a diagram illustrating a layout of the quantum bit (Qubit) array.

### DESCRIPTION OF EMBODIMENTS

Hereinafter, embodiments of the invention will be described with reference to the drawings. In the drawings, the same configurations are denoted by the same reference signs, and a detailed description of repeating parts is omitted.

### Embodiment 1

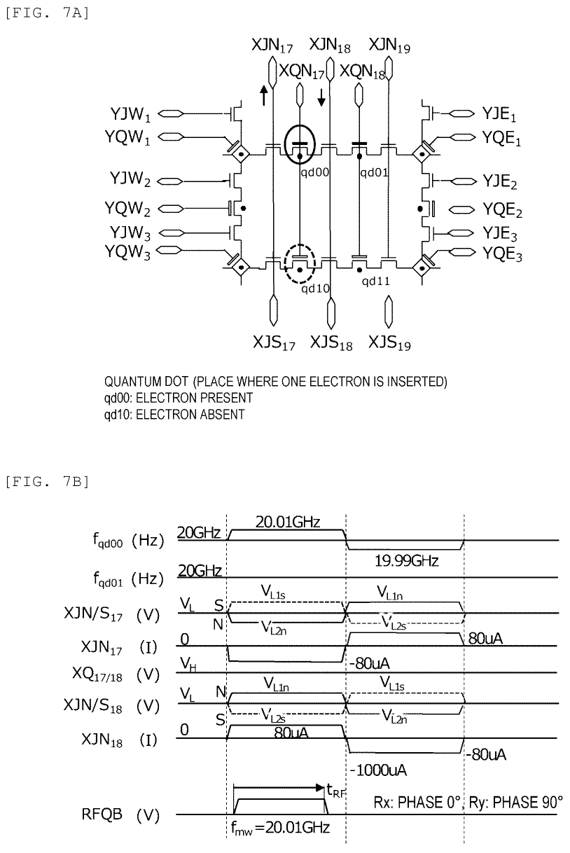

With reference to FIGS. 6 to 12, a quantum bit array chip according to Embodiment 1 of the invention, a quantum computer using the quantum bit array chip, and a computing method using electron shuttling will be described.

First, the quantum bit (Qubit) array according to the embodiment will be specifically described with reference to FIG. 6. FIG. 6 is a circuit diagram of the quantum bit (Qubit) array according to the embodiment.

In the circuit diagram, memory areas are arranged on both sides of a central computing area, an initialization area is arranged on a left side thereof, and a sense area is arranged on a right side thereof. In the array, a quantum dot control gate MOS (whose gate is connected to XQ) and an interaction control gate MOS (whose gate is connected to XJ) are alternately arranged in an X direction, and a silicon channel C having an SOI structure is arranged in the X direction, so that electrons can move and interact between quantum dots via a transfer gate.

In addition, a quantum dot control gate MOS (whose gate is connected to YQ) and an interaction control gate MOS (whose gate is connected to YJ) are alternately arranged also in a Y direction, and the silicon channel C having the SOI structure is arranged in the Y direction, so that electrons can move and interact between the quantum dots via the transfer gate. A quantum dot control gate MOS (whose gate is connected to YQ) is disposed at an intersection of the silicon channel C in the X direction and the silicon channel C in the Y direction.

In the computing area, 16 MOS used as quantum dots are arranged in 8 rows×2 columns. Quantum computing such as Rx/Ry and Swap are performed in this area. In the memory areas on both sides thereof, a quantum dot array of 8 rows×16 columns is arranged, and quantum dots of 17 rows×1 column are arranged at a boundary of the computing area.

In the initialization area, a quantum dot array of 8 rows and 2 columns and quantum dots of 17 rows and 1 column on the left side thereof are arranged. In the sense area, a quantum dot array of 8 rows and 3 columns and quantum dots of 17 rows and 1 column on the right side thereof are arranged. In FIG. 6, elements repeatedly arranged in the X direction and the Y direction are omitted.

One side of the silicon channel C is commonly connected to a reservoir terminal Nres at an array end portion in both the X direction and the Y direction, and the other side thereof is separated as a DOE/DOS terminal. Although not shown as wiring, an RF signal RFQB is arranged on this array by multilayer wiring.

As described above, the quantum bit array is divided into the memory areas and the computing area, and the Rx/Ry and Swap computing are performed only in the computing area, so that a variation control target of the quantum bit can be limited, and the control can be facilitated.

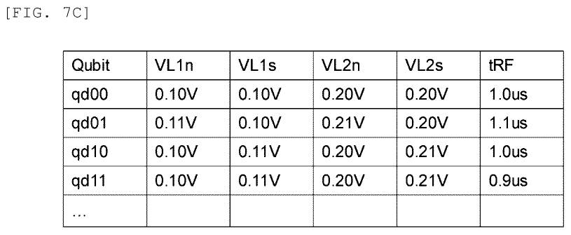

A method of computing control in a quantum dot unit will be described with reference to FIGS. 7A to 7C. FIG. 7A is a diagram illustrating an extracted part of the computing area in FIG. 6. FIG. 7B is a diagram illustrating operation waveforms of quantum dot unit computing control. FIG. 7C illustrates an example of a parameter table in a control chip.

In this chip, computing for one quantum bit (Qubit) includes computing of spin rotation (Rx) around an X axis and spin rotation (Ry) around a Y axis. In each these, a direction of a spin holding quantum information of a quantum bit (Qubit) is rotated by 90° around the X axis and the Y axis of the Bloch sphere.

As an example of control when performing the Rx/Ry computing, control by a dynamic resonance frequency changing method is illustrated in FIGS. 7A to 7C. FIG. 7B illustrates an example of operation waveforms when operating a Qubit qd00 in the array circuit diagram illustrated in FIG. 7A. First, a resonance frequency of spin precession of electron in all Qubits is set to 20 GHz by applying a static magnetic field to the entire chip.

When performing computing, voltages of V_{L2n}, V_{L1s}, V_{L1n}, V_{L2s} are applied to terminals XJN₁₇, XJS₁₇, XJN₁₈, XJS₁₈, respectively, and a current of about 80 uA is applied from XJS₁₇ to XJN₁₇ and from XJN₁₈ to XJS₁₈. Due to a local magnetic field generated by this current, a resonance frequency f_{qd00} of spin precession of an electron in qd00 increases from 20 GHz in a standby state to 20.01 GHz.

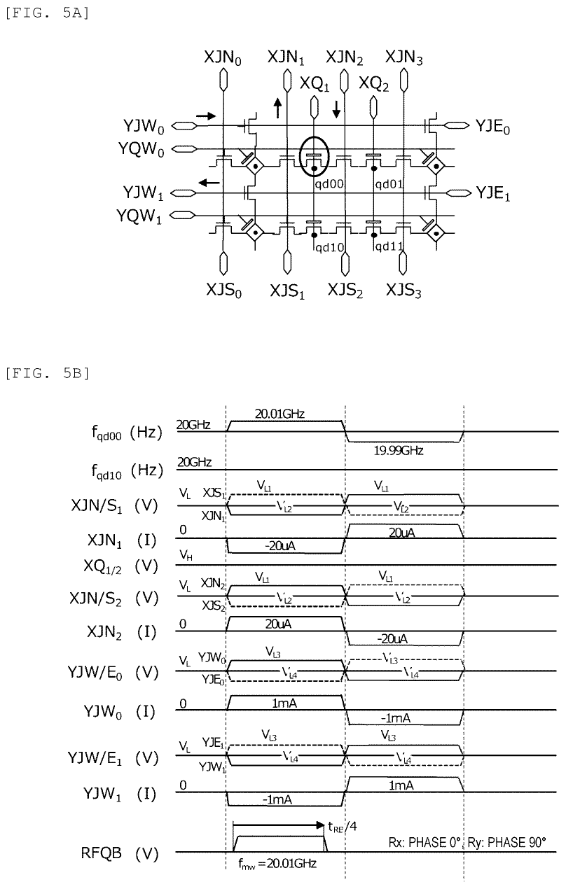

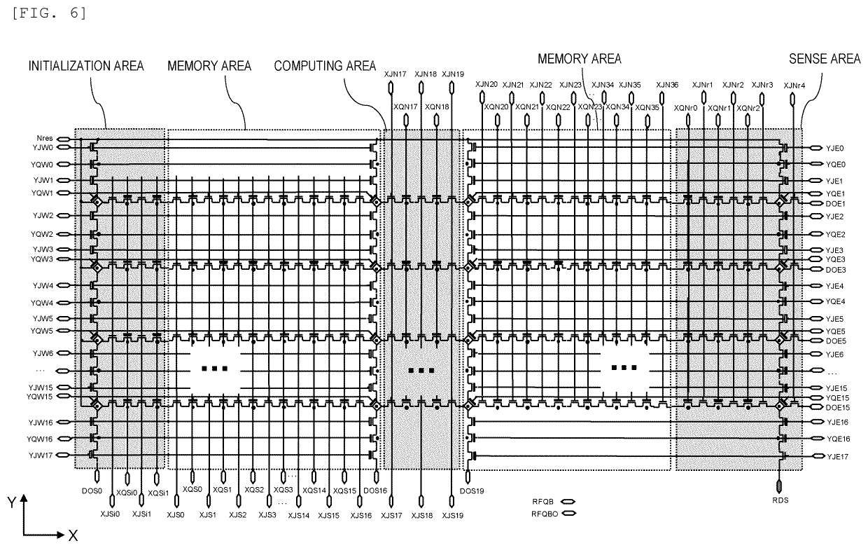

At this time, differently from FIG. 5A, since the resonance frequency of the electron is controlled to 20.01 GHz only by a current flowing through an XJ terminal, a current value is increased, and the same local magnetic field is applied to other quantum dots including qd10 whose gate is connected to XON₁₇. Therefore, selective quantum computing is performed by performing an electron shuttling operation in the array in advance and inserting an electron only in the quantum dot of qd00.

In this state, when the RF signal RFQB of 20.01 GHz is applied to the entire chip for a time of ¼ of a Rabi oscillation period t_{RB}, only an electron spin in qd00 having the coincident resonance frequency can be selectively rotated by 90°. At this time, when a phase of the RF signal is coincident with a phase of the pin precession, the rotation around the X axis is performed, and when a difference of 90° is provided, the rotation around the Y axis can be implemented. Finally, after the voltages applied between the terminals XJN₁₇ and XJS₁₇ and XJN₁₈ and XJS₁₈ are inverted and the f_{qd00} is set to 19.99 GHz, the phase change of the spin precession is compensated for by standing by for the same time.

At this time, a distance between the quantum bit qd00 and the gate XJN₁₇ in FIG. 7A may be different from a distance between the quantum bit qd10 and the gate XJN₁. In this case, an optimum value of the current applied to XJN₁₇ to set the resonance frequencies f_{qd00} and f_{qd10} of the spin precession of these quantum bits to 20.01 GHz differs from 80 uA.

In addition, in quantum bits spatially separated in the array, when an RF signal is applied to the entire chip, the received signal intensity may be different. In this case, since the Rabi oscillation period t_{RB} varies depending on the quantum bit, an optimum application time of the RF signal for rotating the spin of the selected qubit by 90° varies.

Therefore, the optimum applied voltages V_{L1n}, V_{L1s}, V_{L2n}, V_{L2s} and application times t_{RF} of electromagnetic waves when applying a current to the gate for each quantum dot are stored in a parameter table as illustrated in FIG. 7C. The voltages applied from the control chip and the times can be optimized depending on the location of the quantum dot on which the quantum computing is performed. The parameter table may be provided on a quantum bit chip or may be provided on a different control chip.

By this control, even when the number of quantum bits integrated in the quantum bit array chip increases and the characteristic variation increases, an operation condition for each bit can be set, and the computing accuracy can be improved. In addition, by limiting the quantum bit for performing the quantum computing, it is possible to restrict an increase in parameter table size for storing operation conditions necessary for the control.

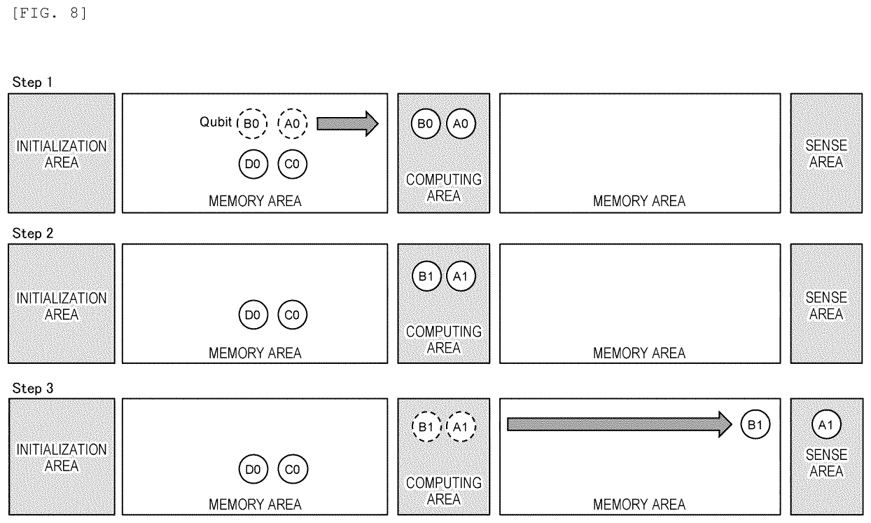

FIG. 8 illustrates a computing control method by electron shuttling. FIG. 8 schematically illustrates an initialization area, a memory area, a computing area, and a sense area in the quantum bit array in FIG. 6. A case is illustrated where there are four quantum bits A0, B0, C0, and D0 in the memory area, and A1 and B1 are obtained by performing computing using A0 and B0 among the four quantum bits.

In step 1, the quantum bits A0 and B0 are moved to the computing area by shuttling. At this time, C0 and D0 are held in the memory area. In step 2, quantum computing is selectively performed on A0 and B0 to obtain A1 and B1. In step 3, the quantum bits A1 and B1 having a computing result are sequentially moved to the sense area by shuttling, and spin information is read.

When such a computing method is used, since the computing area can be limited to a constant size even when the memory area is enlarged in order to increase the number of quantum bits to be computed, there is an advantage that the size of the parameter table for coping with the characteristic variation can be made constant.

In addition, in the operation of the sense area, the same optimum value control as in FIG. 7C is required, but there is an advantage that the size of the parameter table can be made constant since the sense area is also limited.

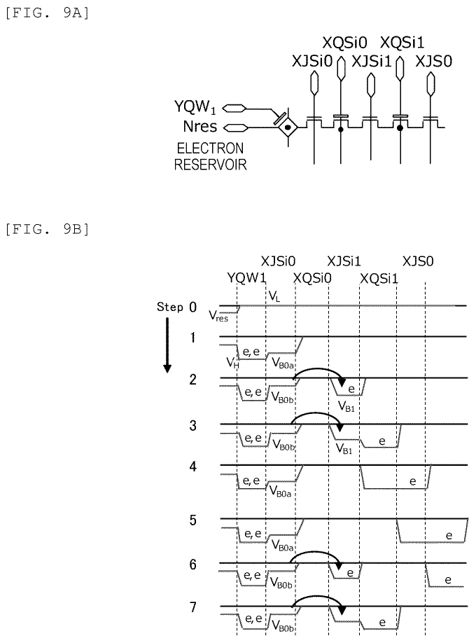

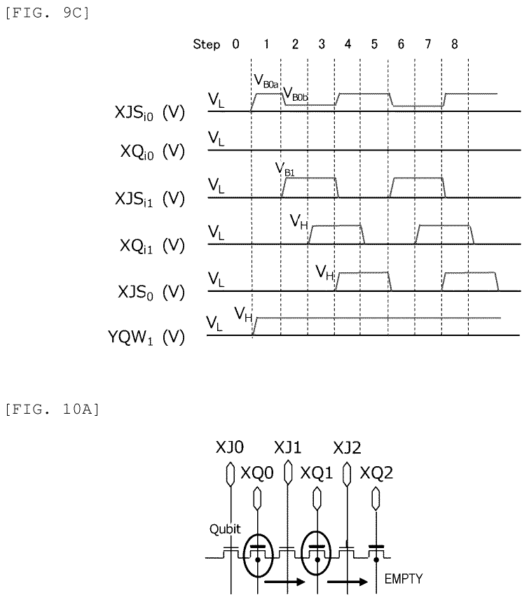

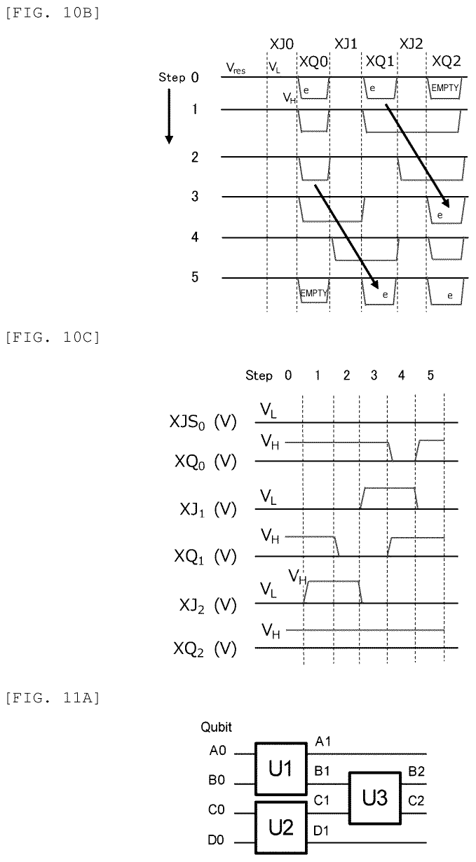

As an initialization method of the quantum bit array, a method of filling one electron in a quantum dot using pumping and transferring the electron to an end of the array is illustrated in FIGS. 9A to 9C. FIG. 9A is a circuit diagram, FIG. 9B is a potential diagram for each step, and FIG. 9C illustrates operation waveforms.

The reservoir terminal Nres is fixed to a voltage Vres, and an YQW₁ terminal is fixed to a high voltage V_{H}, so that electrons can be supplied. By forming a potential barrier for pumping with a MOS structure in which terminals XJSᵢ₀ and XQSᵢ₀ are input to its gate and adjusting a height of the barrier, only one electron can move at a time. A voltage of XQSᵢ₀ is constant at a low voltage V_{L}, and XJSᵢ₀ is changed between intermediate voltages V_{B0a} and V_{B0b}. When XJSᵢ₀ has V_{B0b}, only one electron crosses the barrier and enters a potential well formed below XJSᵢ₁. The electron can be moved in a right direction of the array by shuttling by a pulse applied to XQSᵢ₁ and XJS₀.

Since this operation is simultaneously performed by MOS transistors whose gates are commonly connected in the X direction, the initialization operation can also be performed in all rows of the array. Alternatively, by lowering YQW₁ to YQW₁₅ to V_{L} and blocking electrons, it is possible to perform the initialization operation only in the selected row and inject electrons.

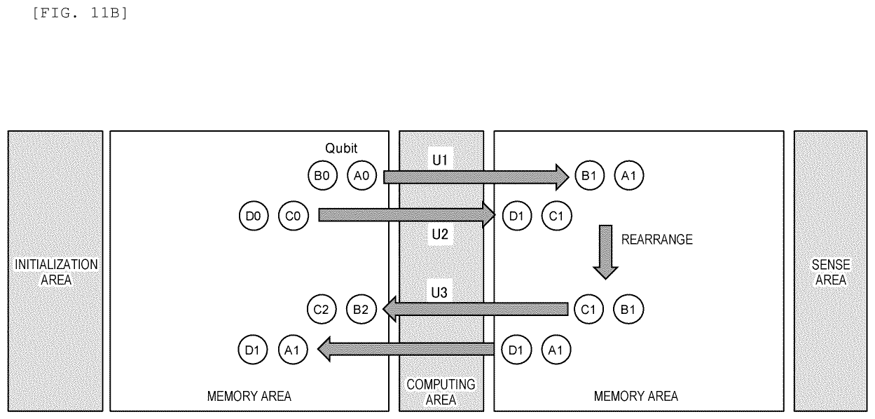

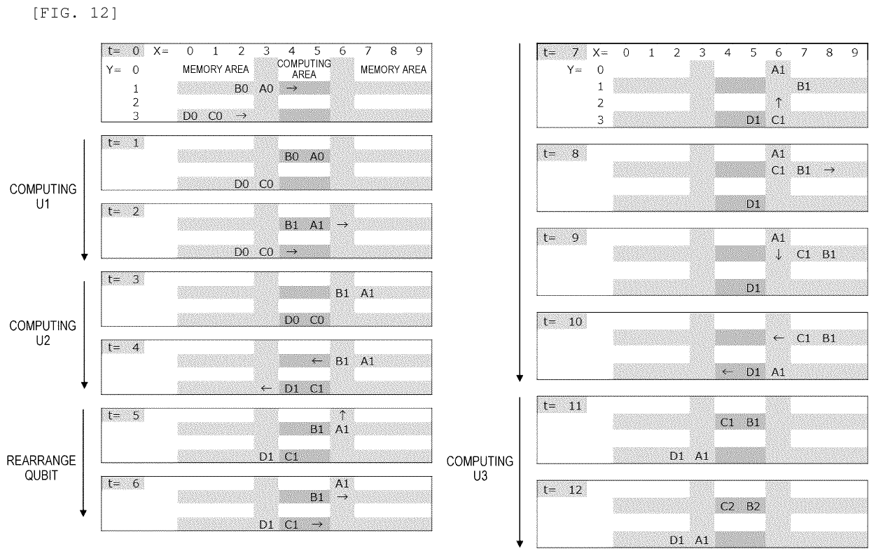

FIGS. 10A to 10C show how electrons move into the quantum bit array using this method. FIG. 10A is a circuit diagram, FIG. 10B is a potential diagram for each step, and FIG. 10C illustrates operation waveforms. While the XQ and XJ wirings are controlled to simultaneously control all rows, depths of adjacent potential wells are set to V_{H}, and electrons are moved from left to right.

By moving the electrons by a shuttling method as described, the electrons can be moved between the computing area and the memory area, and even when the quantum computing is executed only in the computing area, the computing can be executed with any quantum bit.

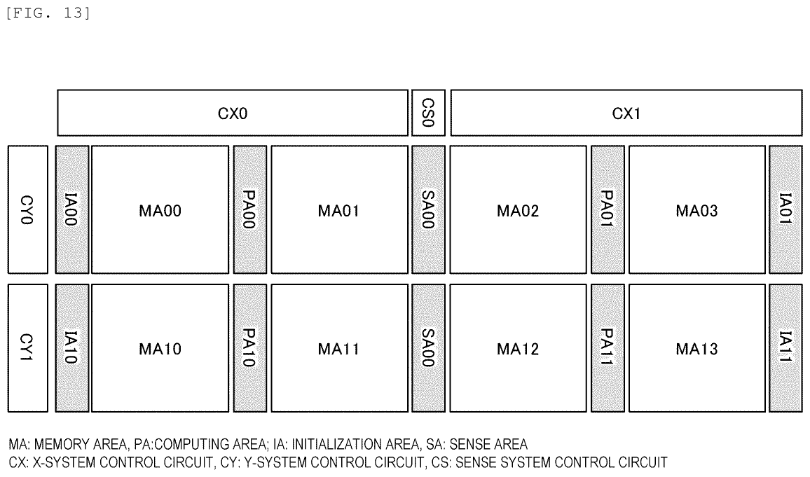

FIG. 11A and FIG. 11B illustrate an example of quantum computing by shuttling electrons to be quantum bits. The computing example in FIG. 11A illustrates a case where, for four quantum bits A0, B0, C0, and D0, computing in which 1 quantum computing and 2 quantum computing are combined is performed between A0 and B0 to output A1 and B1, computing in which 1 quantum computing and 2 quantum computing are combined is performed between C0 and D0 to output C1 and D1, and computing in which 1 quantum computing and 2 quantum computing are combined is performed between B1 and C1 to output B2 and C2.

As illustrated in the computing step in FIG. 11B, the quantum bits A0 and B0 are moved to the computing area by the shuttling, and the quantum computing is selectively performed to obtain A1 and B1. Subsequently, the quantum bits C0 and D0 are moved to the computing area by the shuttling, and the quantum computing is selectively performed to obtain C1 and D1. Thereafter, the quantum bits are rearranged so that the quantum bits B1 and C1 are adjacent to each other. Finally, the quantum bits B1 and C1 are moved to the computing area, and the quantum computing is performed to obtain B2 and C2.

As described above, the quantum computing can be performed on any quantum bit pair by rearranging adjacent quantum bits by the shuttling.

FIG. 12 schematically illustrates a method Of rearranging the order of electrons in quantum dots, that is, quantum bits, by shuttling, using quantum dots of 2 rows and 10 columns.

In FIG. 12, the quantum dots in the memory area are indicated by light gray hatching areas, and the quantum dots in the computing area are indicated by dark gray hatching. It is assumed that there is no channel in a white portion and electrons cannot be moved therein.

At time t=0, four quantum bits A0, B0, C0, and D0 are arranged as illustrated in FIG. 12. After A0 and B0 are moved to the computing area by shuttling, the quantum computing U1 is performed at time t=1 and 2. Similarly, after C0 and D0 are moved to the computing area by shuttling, the quantum computing U2 is performed at time t=3 and 4.

Thereafter, at time t5 to time 10, the quantum bits A1, B1, C1, and D1 of the computing result are rearranged, and B1 and C1 are adjacent to each other. At this time, as indicated by time t=6 to 9, A1 is moved to a quantum dot of (X, Y)=(6, 0), so that the order of A1, B1, and C1 is exchanged. Finally, the quantum computing U3 is performed at time t=11 and 12 to obtain final computing results B2 and C2.

As illustrated in the embodiment, the order of electrons can be easily exchanged by creating a row of Y=0 or 2, in which no quantum dot is disposed, in the quantum bit array.

### Embodiment 2

With reference to FIGS. 13 to 15, a quantum bit array chip, a quantum computer using the quantum bit array chip, and a computing method using electron shuttling according to Embodiment 2 of the invention will be described.

FIG. 13 is a diagram illustrating a quantum bit array of the embodiment, and schematically illustrates a quantum bit array size expansion method. In the embodiment, a method will be described in which a plurality of memory areas MA, computing areas PA, initialization areas IA, and sense areas SA are arranged to expand the array size and increase the number of quantum bits. In the embodiment, an example is illustrated in which the array in FIG. 6 is arranged in the X direction in an inverted manner with the sense area as a boundary, and the same configuration is repeatedly extended in the Y direction.

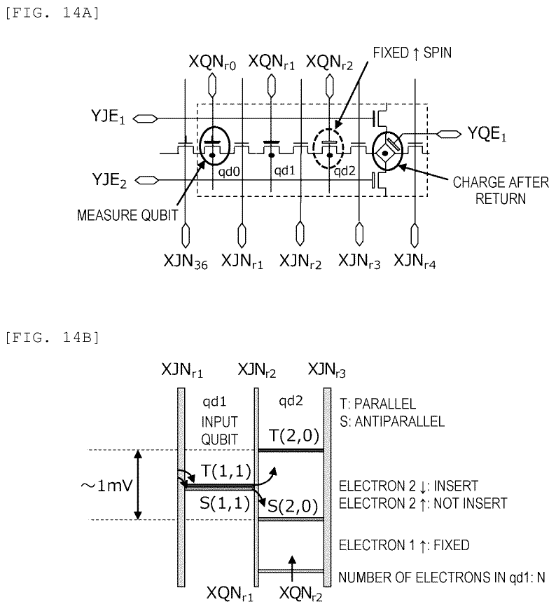

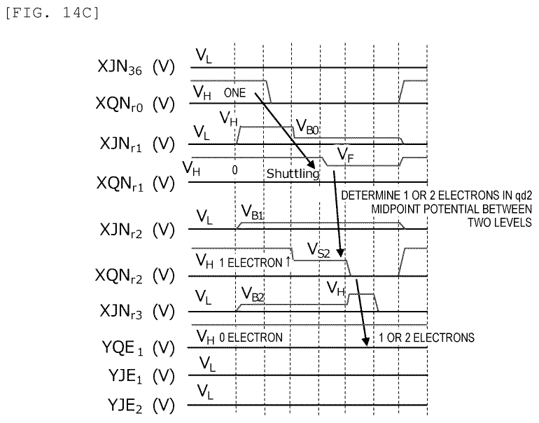

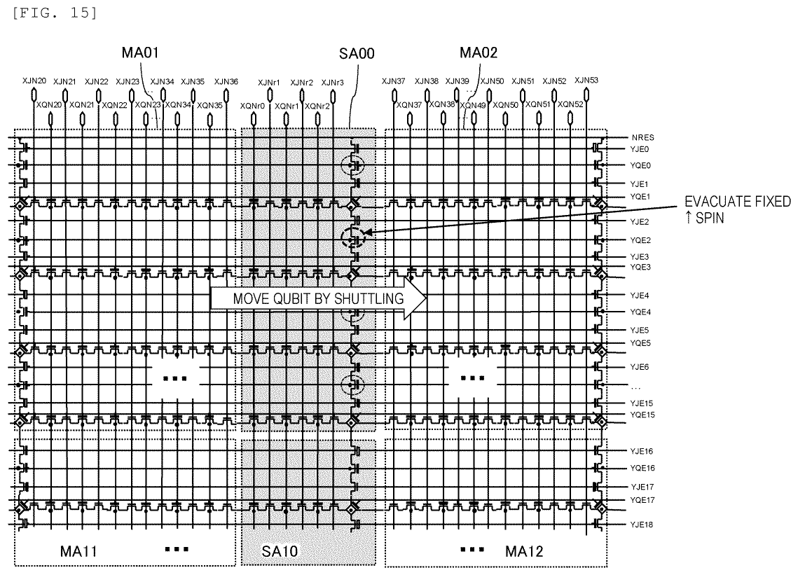

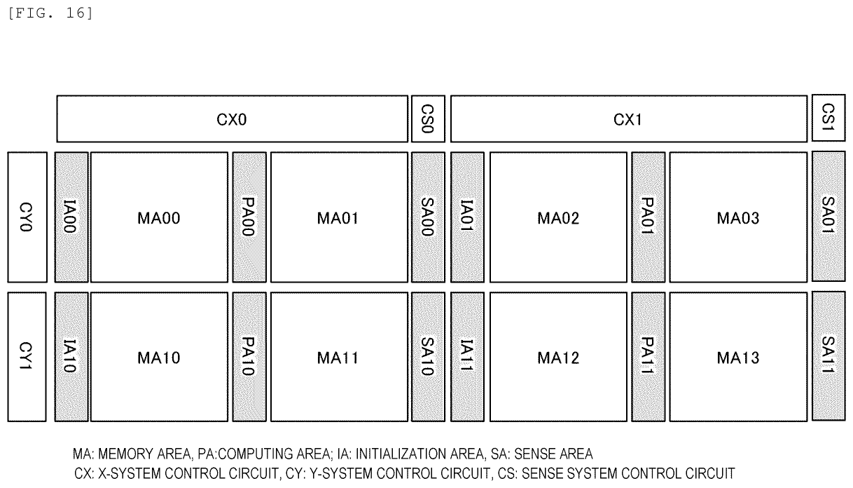

FIGS. 14A to 14C illustrate an operation of the sense area SA in the quantum bit array. The computing result is read by sensing information on a spin of an electron constituting a quantum bit (Qubit). For this purpose, first, the direction of the spin of the quantum bit (Qubit) that stores quantum information of the computing result is converted into an electric charge amount (one or two electrons) in the sense area SA, and the electric charge amount is moved to a comparator outside the array by shuttling to be converted into classical digital information. When the quantum bit (Qubit) holds an intermediate state between “0” and “1”, “0” or “1” is read with a probability proportional to the state.

FIG. 14A is a circuit diagram, and FIG. 14B is a potential diagram of quantum dots included in the circuit in FIG. 14A. FIG. 14C illustrates operation waveforms when spin information of a quantum bit (Qubit) included in a quantum dot qd0 whose gate electrode is connected to XQNᵣ₀ is converted into an electric charge. Here, although only one row of quantum dots is illustrated, the control line is connected to the quantum dots of all the rows, and the same operation is performed in these quantum dots. For quantum dots qd1 and qd2 whose gate electrodes are connected to XQNᵣ₁ and XQNᵣ₂, a transfer gate whose gate electrode is connected to XJNᵣ₁, XJNᵣ₂, XJNᵣ₃ is used as a barrier.

At the end of the computing, a voltage of the control line XJN is held at V_{L}, and the control line XQN is held at V_{H}. By setting XJNᵣ₁ to V_{H} and performing shuttling, the quantum bit (Qubit) in qd0 is moved to qd1. In the quantum dot qd2, one electron with an upward spin is disposed in advance at the time of initialization. XJNᵣ₁ is set to a bias voltage V_{B0}, XJNᵣ₂ is set a bias voltage V_{B1}, XQNᵣ₂ is set to a bias voltage V_{S2}, and the quantum dot qd2 is set to a potential state in which only two electrons can exist.

Subsequently, XQNᵣ₁ is set to a bias voltage V_{F}. Here, these bias voltages are set so that quantum levels of T(1, 1) and S(1, 1) in qd1 are between quantum levels of T(2, 0) and S(2, 0) in qd1. Accordingly, a spin blockade state is formed in which only electrons having downward spins among the electrons in qd1 can pass through qd1 and the barrier and electrons having upward spins cannot enter qd1.

That is, if the computing result is “0” and the electrons of qd1 have upward spins, the number of electrons in qd2 is maintained at 1, and if the computing result is “1” and the electrons of qd1 have downward spins, the number of electrons in qd2 increases to 2. By setting XJNᵣ₃ and XJSᵣ₃ to V_{H}, in each row, this electric charge is moved to a quantum dot qd3 whose gate is controlled by YQE₁, and is held as a sensing result. This electric charge is moved to the outside of the array by shuttling and read as classical “0” or “1”.

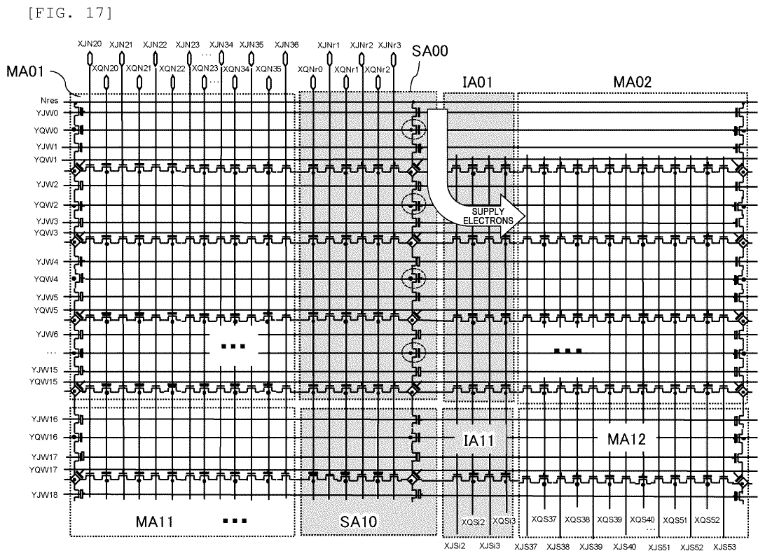

FIG. 15 illustrates a circuit diagram of the sense area SA in the central portion of the array in FIG. 13. In this array, electrons are moved from the memory area MA01 to the memory area MA02 by shuttling, so that the number of quantum bits used for computing can be increased. At this time, the electrons having upward spins used when performing the spin blockade in a sense amplifier area are evacuated by shuttling to the quantum dot controlled by the gate of YQE₂ indicated by a thick dotted line in FIG. 15.

With this operation, when computing is performed via a plurality of memory areas MA, a result read operation can be immediately performed.

### Embodiment 3

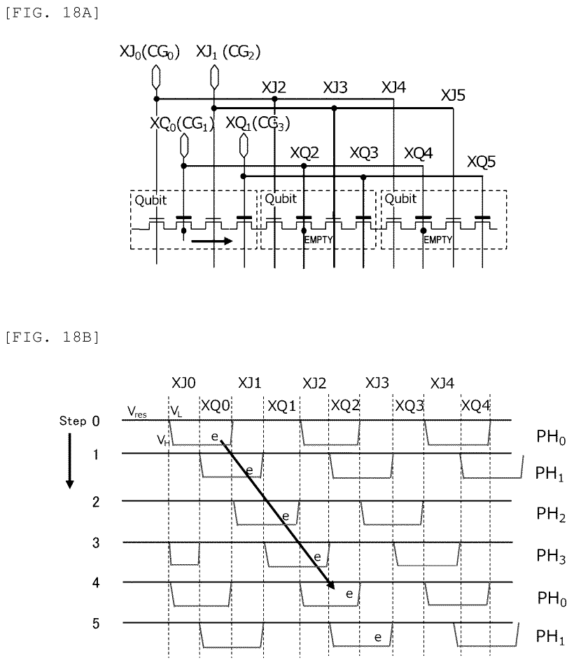

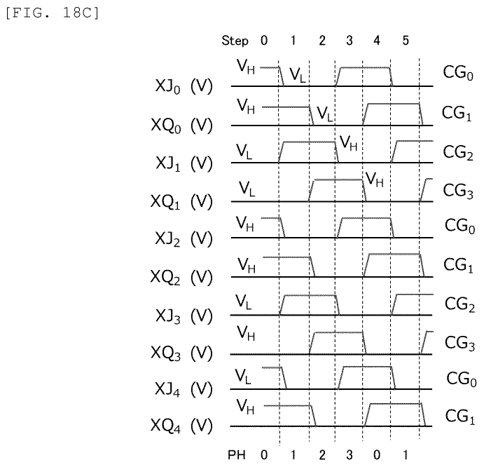

With reference to FIGS. 16 and 17, a quantum bit array chip, a quantum computer using the quantum bit array chip, and a computing method using electron shuttling according to Embodiment 3 of the invention will be described.

In the embodiment, a method will be described in which a plurality of memory areas MA, computing areas PA, initialization areas IA, and sense areas SA are arranged to expand the array size and increase the number of quantum bits. As illustrated in FIG. 16, in the embodiment, an example is illustrated in which the array in FIG. 6 is expanded by repeating the same configuration in both the X direction and the Y direction.

FIG. 17 is a circuit diagram of the sense area SA and the initialization area IA in the central portion of the array in FIG. 16. FIG. 17 is a diagram illustrating an electron supply method at the time of initialization.

In this array, electrons are moved from the memory area MA01 to the memory area MA02 by shuttling, so that the number of quantum bits used for computing can be increased.

At the time of initialization, electrons are supplied to the initialization area IA via an MOS transistor controlled by YQ and YJ gates in the sense amplifier area. Accordingly, the number of MOS transistors that connect the array in the Y direction can be reduced to one column, and area and control time of a control circuit can be reduced.

### Embodiment 4

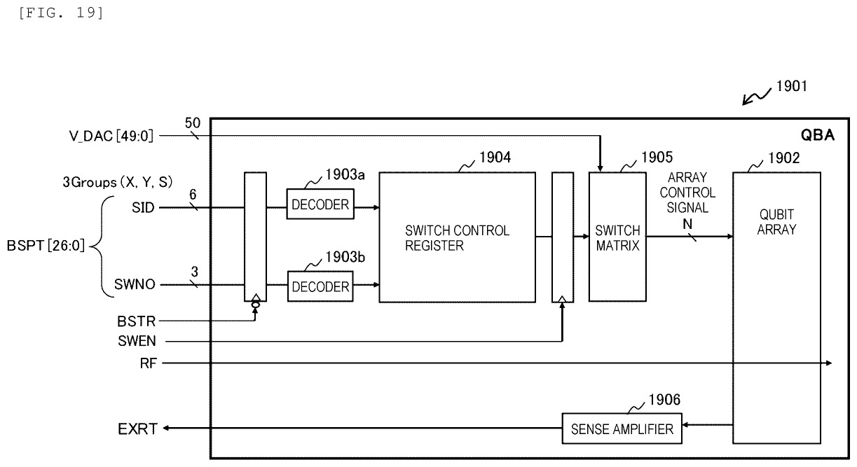

With reference to FIGS. 18A to 26, a quantum bit array chip, a quantum computer using the quantum bit array chip, and a calculation method using electron shuttling according to Embodiment 4 of the invention will be described.

In Embodiment 1 (FIGS. 10A to 10C), an example in which the control lines of the quantum bit array are controlled one by one to perform shuttling has been described. In the example of the memory area and the computing area illustrated in the array in FIG. 6, it is necessary to set a voltage from the outside of the chip for each of 37 control lines of XJ, 34 control lines of XQ, and 8 control lines of YQ.

FIG. 18A to FIG. 18C illustrate operations in a case of performing shuttling simultaneously in the entire array. As illustrated in the circuit diagram of FIG. 18A, two XJ gates and two XQ gates form one group, and one quantum bit is held. Correspondingly, the entire array control signal lines are divided into four groups. The even-numbered XJ gates are grouped as CG0 and commonly connected. The odd-numbered XJ gates are grouped as CG2 and commonly connected. The even-numbered XQ gates are grouped as CG1 and commonly connected. The odd-numbered XQ gates are grouped as CG3 and commonly connected.

FIG. 18B illustrates a potential diagram formed by these gates, and FIG. 18C illustrates operation waveforms. By commonly controlling the groups CG0 to CG3 between the high level V_{H} and the low voltage V_{L}, it is possible to control the potential to simultaneously move the quantum bits in the right direction by shuttling in the entire array.

At this time, since it is sufficient to set voltages for these 4 groups from the outside of the chip, it is possible to facilitate the shuttling control and shorten the time required for the shuttling.

In order to describe a configuration of a switch matrix and a switch control register connected to the array control signal line, the configuration of the quantum bit array chip (QBA) is illustrated in FIG. 19.

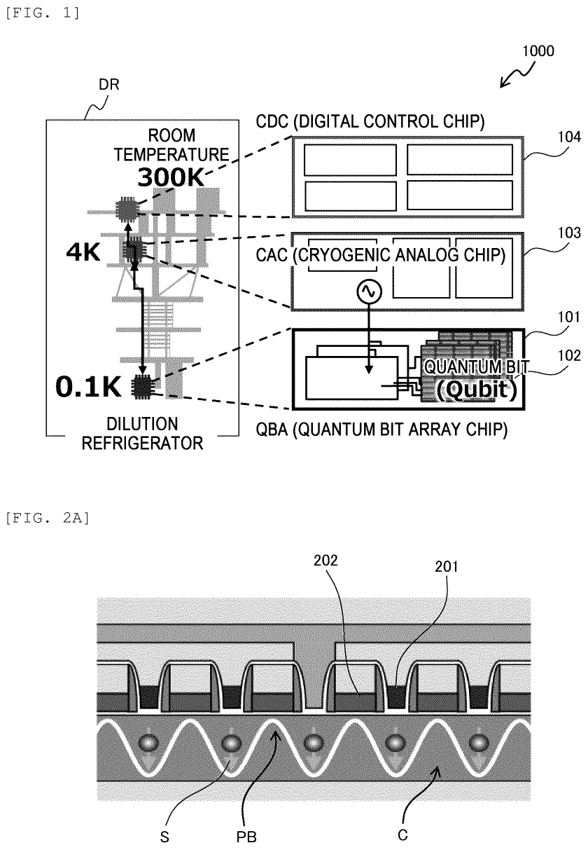

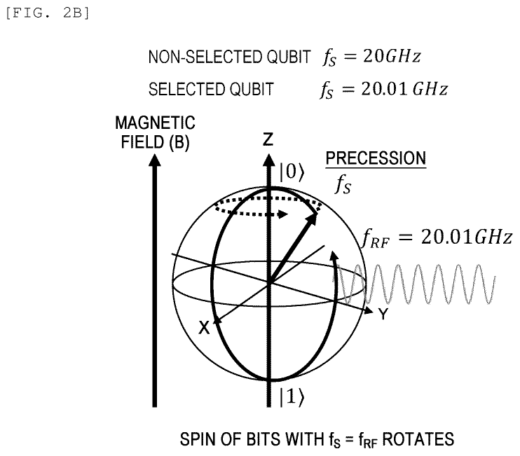

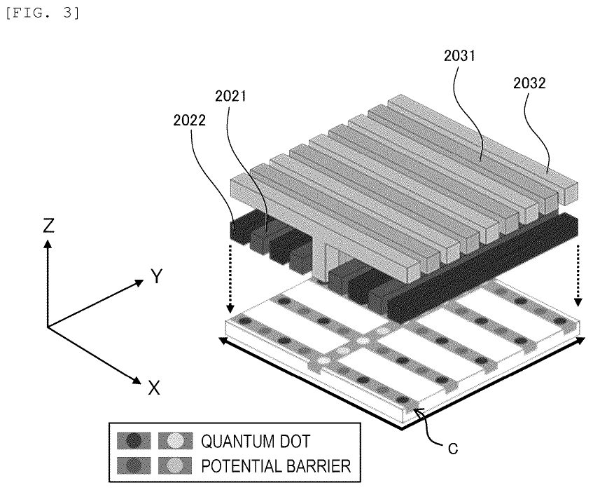

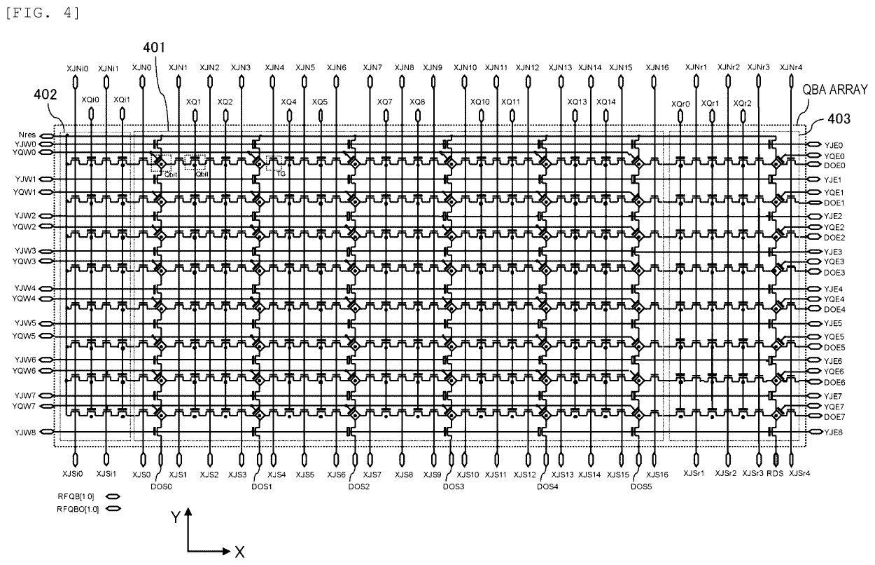

50 types of array and bias voltages V_DAC are supplied from the cryogenic analog chip (CAC: reference sign 103 in FIG. 1) to a quantum bit array chip (QBA) 1901. In order to control how the bias voltage is applied to each quantum bit array control signal line in a quantum bit (Qubit) array 1902, a bias pattern signal BSPT and a bias pattern strobe signal BSTR are input to the QBA 1901.

Inside the QBA 1901, a combination of a quantum bit array control signal line and a control voltage is defined by a total of 9-bit signals of a 6-bit control line address SID and a 3-bit control line voltage SWNO. The bias pattern signal BSPT enables information of three control lines to be simultaneously input by signals of a total of 27 lines of 3 groups of X, Y, and S indicated by the control line address SID of the quantum bit array control signal line.

These pieces of information are decoded by decoders 1903a and 1903b and then held in a switch control register 1904, and a switch matrix 1905 is switched based on a state of the switch control register 1904 to output a desired bias voltage to the quantum bit array control signal line. This timing is defined by a control signal enable SWEN.

The RF signal for quantum computing is input from the RF and then propagated on the wiring on the quantum bit (Qubit) array 1902. A result of the quantum computing performed by the Qubit array 1902 is converted into classical digital information by a sense amplifier 1906 and output to the cryogenic analog chip (CAC) 103 via EXRT.

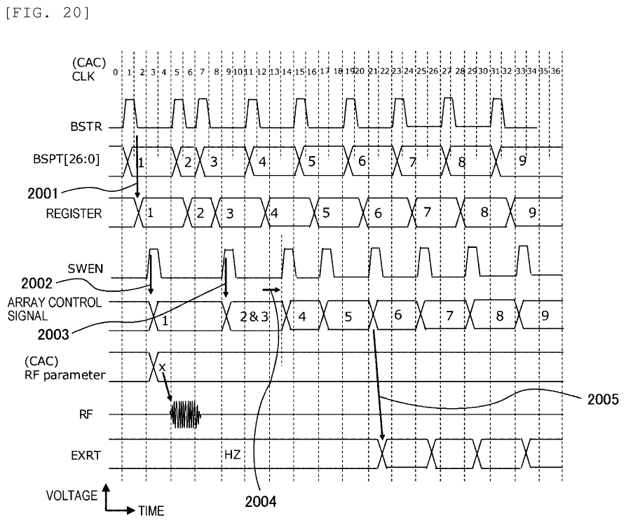

An example of a timing chart is illustrated in FIG. 20 in order to describe a signal interface method that defines the operation of the quantum bit array chip (QBA) 1901.

The cryogenic analog chip (CAC) 103 outputs the bias pattern signal BSPT in accordance with a system clock CLK, and outputs the bias pattern strobe signal BSTR for controlling an output timing of the bias pattern. In the QBA 1901, the bias pattern signal BSPT is latched and decoded at a falling edge of the bias pattern strobe signal BSTR, and then stored in the switch control register 1904 in the QBA 1901. In the switch matrix 1905 that is an analog matrix switch, a voltage selected from the bias voltage V_DAC is connected to the quantum bit array control signal line, and this timing is defined by the control signal enable SWEN.

Here, a pattern 1 input at a clock 2 is output to the switch control register 1904 (reference sign 2001 in FIG. 20), and is output as an array control signal at a clock 3 (reference sign 2002 in FIG. 20). At this time, for the quantum bit array control signal line to which no information is input at the timing when the bias pattern strobe signal BSTR is input, a previously set bias voltage is continuously output from the switch matrix 1905.

In the embodiment, the number of groups of control signal patterns that can be input in 1 cycle is at most three, and in order to change three or more control signals, it is necessary to update the switch control register 1904 in a plurality of cycles. Here, control patterns 2 and 3 input at clocks 6 and 8 are output as the array control signal by the control signal enable SWEN activated at a clock 9 (reference sign 2003 in FIG. 20). The control signal enable SWEN can also be used to cause the control signal to transition at a timing independent of the system clock. An example is illustrated in which a control pattern 4 input at a clock 12 is output as the array control signal at a timing finely adjusted (reference sign 2004 in FIG. 20).

As described above, the number of input signals of the QBA 1901 can be limited by supplying information on the bias voltage applied to a large number of quantum bit array control signal lines to the QBA 1901 in a time division manner.

Further, since a timing generation circuit can be omitted in the QBA 1901 by inputting the bias pattern strobe signal BSTR and the control signal enable signal SWEN that define the operation timing of the internal circuit of the QBA 1901 from the CAC 103, the power consumption of the QBA 1901 can be reduced.

The RF signal is applied from the RF signal RFQB at a timing defined in the CAC 103, and is used for computing processing of the quantum bit (Qubit) 102. By inputting sense amplifier control signal patterns 6 to 9 to clocks 20 to 32, a computing result is read from the data output terminal EXRT (reference sign 2005 in FIG. 20).

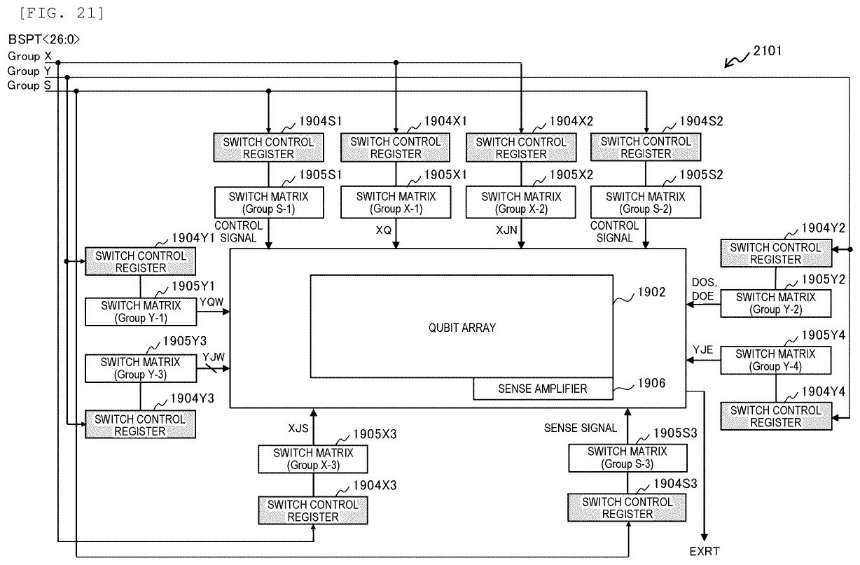

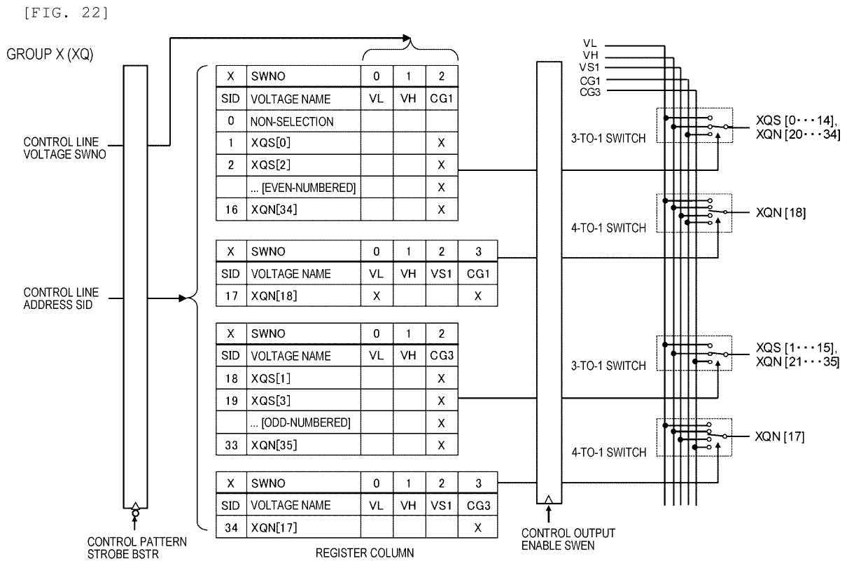

FIG. 21 illustrates a main circuit used in the quantum bit array chip (QBA) 1901. The circuit illustrated in FIG. 21 is implemented as a register and switch block 2101 including the switch control register 1904 for generating an array control signal and the switch matrix 1905, and the switch control register 1904 and the switch matrix 1905 are grouped for each signal and arranged around the quantum bit array 1902 and the sense amplifier 1906.

The bias pattern signal BSPT is divided into Groups X, Y, and S, and input to the corresponding register groups.

The signal of Group X is supplied to the switch control registers 1904 (switch control registers 1904X1, 1904X2, 1904X3) corresponding to a switch (Group X-1) that outputs an array signal XQ, a switch (Group X-2) that outputs an array signal XJN, and a switch (Group X-3) that outputs an array signal XJS.

The signal of Group Y is supplied to the switch control registers 1904 (switch control registers 1904Y1, 1904Y2, 1904Y3) corresponding to a switch (Group Y-1) that outputs an array signal YQW, a switch (Group Y-2) that outputs array signals DOS and DOE, a switch (Group Y-3) that outputs an array signal YJW, and a switch (Group Y-4) that outputs an array signal YJE.

The signal of Group S is supplied to the switch control registers 1904 (switch control registers 1904S1, 1904S2, 1904S3) corresponding to switches (Group S-1, Group S-2) that output a control signal and a switch (Group S-3) that outputs a sensing signal.

As described, by grouping and distributing the quantum bit array control signal lines, connection between the switch matrix 1905 and the array control signal is facilitated. In addition, by dividing the bias pattern signal BSPT into 3 groups of X, Y, and S, it is possible to update information of 3 groups of quantum bit array control signal lines at the same time, and it is possible to shorten the time required for setting the bias voltage.

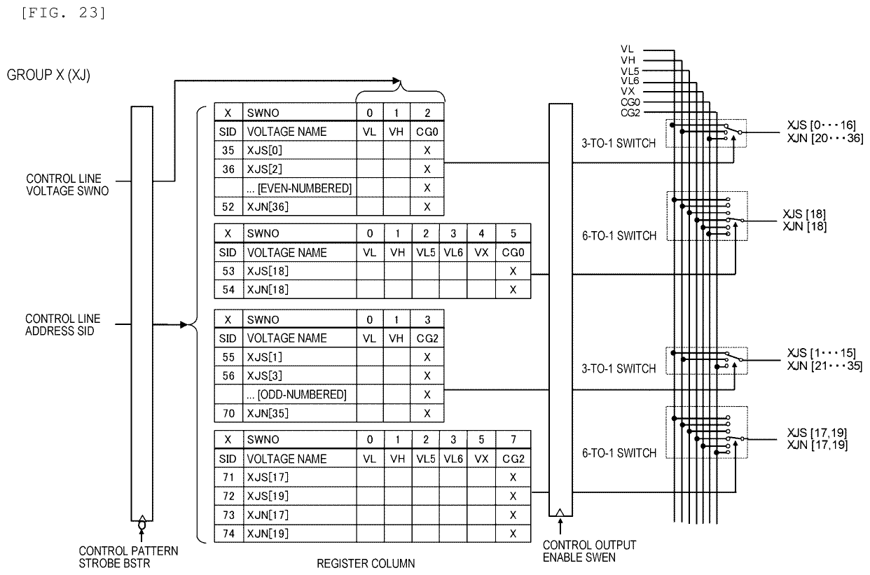

FIG. 22 illustrates a configuration of a first switch control register and a switch matrix when performing shuttling on the entire array. In an upper half block, a 3-to-1 switch matrix is configured that connects two types of bias voltages V_{H} and V_{L} and a common terminal of CG1 to the even-numbered array control signal lines of XQS [0, 2, . . . , 14] and XQN [20, 22, . . . , 34]. In addition, a 4-to-1 switch matrix is configured that connects three types of bias voltages V_{H}, V_{L}, and V_{S1} and the common terminal of CG1 to XQN [18].

In a lower half block, a 3-to-1 switch matrix is configured that connects two types of bias voltages of V_{H} and V_{L} and a common terminal of CG3 to the odd-numbered array control signal lines of XQS [1, 3, . . . , 15] and XQN [21, 23, . . . , 35]. In addition, a 4-to-1 switch matrix is configured that connects three types of bias voltages V_{H}, V_{L}, and V_{S1} and the common terminal of CG3 to XON [17].

When the bias pattern signal BSPT is input from the CAC 103 and taken into the QBA 1901 by the bias pattern strobe signal BSTR, the control line address SID and the control line voltage SWNO corresponding to each of the Groups X, Y, and S are decoded, and the bit of the bias voltage to be output is held in the register of the corresponding array control signal line.

When the control signal enable SWEN is input from the CAC 103, the content of the register is output to the switch matrix, the switch H the corresponding control line is switched, and a predetermined bias voltage is output to the array control signal.

When performing shuttling on the entire array, as illustrated in FIG. 22, the XQS and XQN are connected to CG1 in the upper half block, and the arrays XQS and XQN are connected to CG3 in the lower half block.

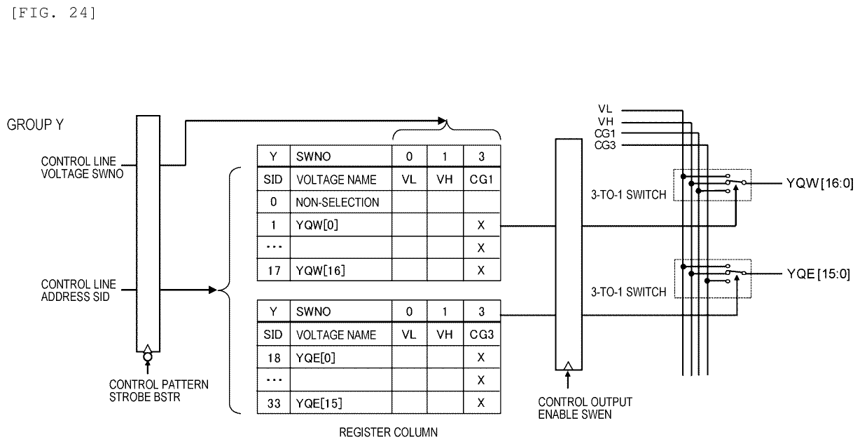

FIG. 23 illustrates a configuration of a second switch control register and the switch matrix. In an upper half block, a 3-to-1 switch matrix is configured that connects two types of bias voltages of V_{H} and V_{L} and a common terminal of CG0 to the even-numbered array control signal lines of XJS [0, 2, . . . , 16] and XJN [20, 22, . . . , 36]. In addition, a 6-to-1 switch matrix is configured that connects five types of bias voltages of V_{H}, V_{L}, V_{VL5L}, V_{VL5}, and V_{X} and the common terminal of CG0 to XJS [18] and XJN [18].

In a lower half block, a 3-to-1 switch matrix is configured that connects two types of bias voltages of V_{H} and V_{L} and a common terminal of CG2 to the odd-numbered array control signal lines of XJS [1, 3, . . . , 15] and XJN [21, 23, . . . , 35]. In addition, a 6-to-1 switch matrix is configured that connects five types of bias voltages of V_{H}, V_{L}, V_{VL5L}, V_{VL5}, and V_{X} and a common terminal of CG2 to XJS [17, 19] and XJN [17, 19].

When performing shuttling on the entire array, as illustrated in FIG. 23, the XJS and XJN are connected to CG0 in the upper half block, and the arrays XJS and XJN are connected to CG2 in the lower half block.

FIG. 24 illustrates a configuration of a third switch control register and the switch matrix. In an upper half block, 3-to-1 switch matrix is configured that connects two types of bias voltages V_{H} and V_{L} and the common terminal of CG1 to the array control signal line of YOW [0, 1, . . . , 16].

In a lower half block, a 3-to-1 switch matrix is configured that connects two types of bias voltages of V_{H} and V_{L} and the common terminal of CG3 to odd-numbered array control signal lines of YQE [0, 1, . . . , 15].

When performing shuttling on the entire array, as illustrated in FIG. 24, YQWN is connected to CG1 in the upper half block, and the array YQE is connected to CG3 in the lower half block.

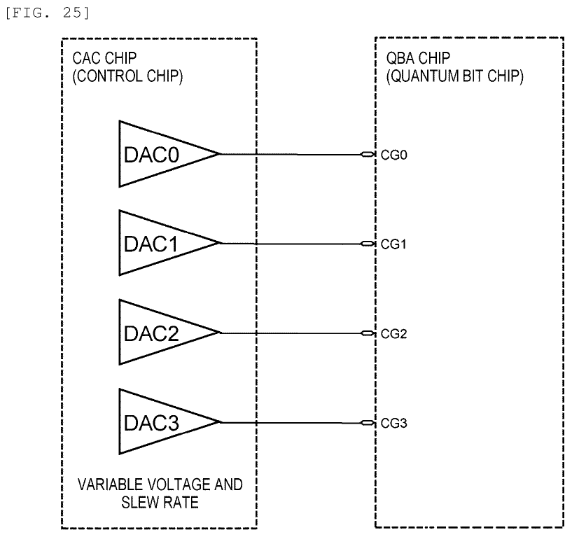

FIG. 25 illustrates a first signal drive method when performing shuttling on the entire array. In the embodiment, the common terminals CG0 to CG3 are used as QBA chip external terminals and are connected to DA converters DAC0 to DAC3 on the cryogenic analog chip (CAC) 103. When performing the shuttling, the voltage of the common terminal is directly transitioned between VL and VH by the DA converter.

At this time, it is known that if the transition time is too short, the fidelity of the quantum state of the quantum bit degrades. Therefore, the degradation of the fidelity is restricted by controlling the signal transition time by the DA converter. In this way, when the voltage is controlled from the outside of the chip, the configuration of the quantum bit array chip (QBA) 1901 can be simplified.

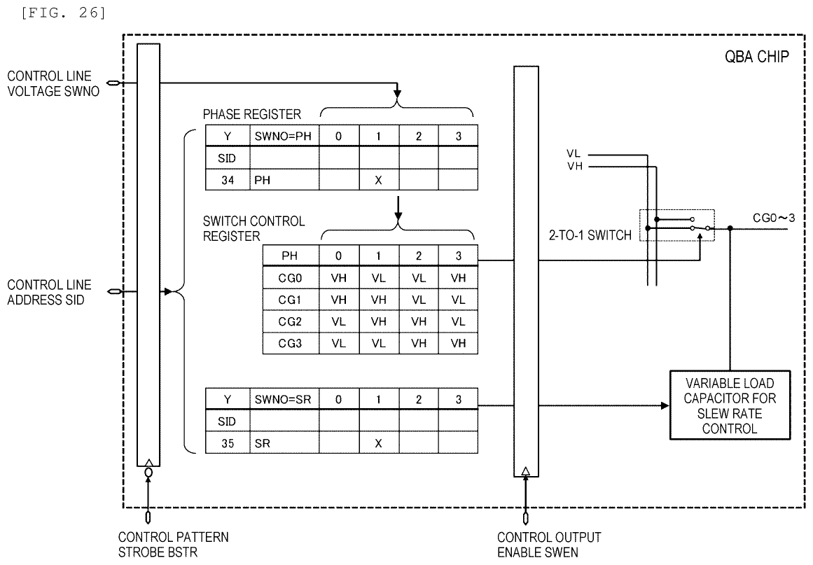

FIG. 26 illustrates a second signal drive method when performing shuttling on the entire array. In the embodiment, a switch matrix and a switch control register for applying the voltage of V_{L} or V_{H} to the common terminals CG0 to CG3 are provided. The switch control register defines voltages to be applied to CG0 to CG3 by phases PH0 to PH3. By controlling the value of the phase register from CAC 103 in the order of PH0 to PH3, it is possible to generate, in CG0 to CG3, voltages necessary for shuttling of the entire array.

Here, variable load capacitors for slew rate control are connected to CG0 to CG3, and by switching the value of the register SR in a range of 0 to 3, the magnitude of the load capacitor is changed, and the slew rate of the signal is controlled. When the voltage is controlled inside the quantum bit array chip (QBA) as in the embodiment, there is an advantage that the slew rate can be accurately controlled since the influence of a parasitic capacitor can be reduced.

As described above, when the shuttling is performed, the array control signal lines are divided into four groups, commonly connected, and collectively controlled, so that it is only necessary to set voltages for the four groups from the outside of the chip, and thus it is possible to facilitate the shuttling control and shorten the time required for the shuttling.

In addition, since a change time of the control signal can be controlled, it is possible to restrict degradation of the fidelity of the quantum bit when the shuttling is performed.

### Embodiment 5

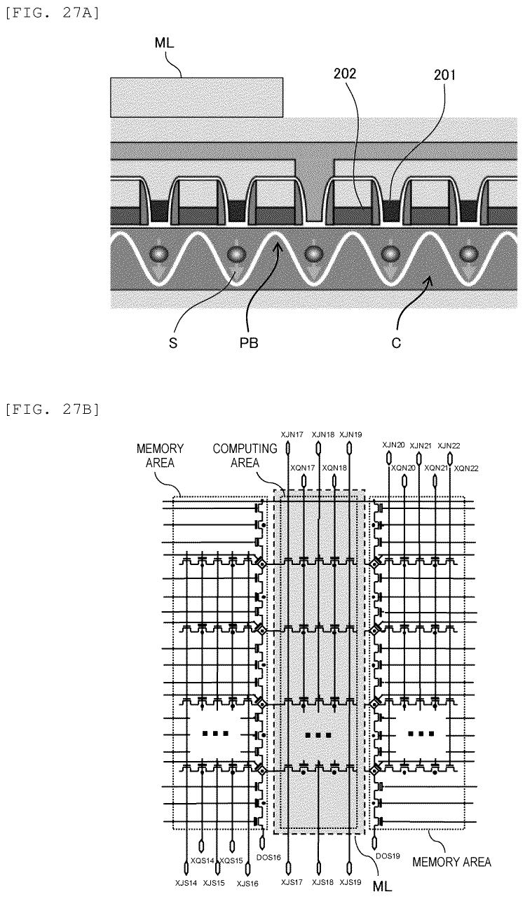

With reference to FIGS. 27A and 27B, a quantum bit array chip, a quantum computer using the quantum bit array chip, and a computing method using electron shuttling according to Embodiment 5 of the invention will be described.

FIGS. 27A and 27B are diagrams illustrating a second selection method (quantum computing method by a local magnetic field) of quantum bits for performing computing in the quantum bit array chip (QBA) 101. FIG. 27A illustrates a cross-sectional structure of the quantum bit (Qubit) array, and FIG. 27B illustrates a layout of the quantum bit (Qubit) array.

In the quantum bit array chip (QBA) 101 of the embodiment, the spin S of a single electron confined in the potential barrier PB formed in the silicon channel C of the MOS structure is used as a quantum bit (Qubit).

FIG. 27A illustrates a state in which electrons are trapped immediately below the quantum dot control gate (XQ) 201 by increasing the voltage of the quantum dot control gate (XQ) 201 and decreasing the voltage of the interaction control gate (XJ) 202. That is, the quantum dot control gate (XQ) 201 functions as a quantum dot capable of trapping electrons, and a quantum bit (Qubit)) is formed by trapping one electron therein. Further, as illustrated in the layout in FIG. 27B, in the computing area, a ferromagnetic film ML is disposed on an upper portion of the MOS structure, and a magnetic field B_{L} by the ferromagnetic film ML is applied. When an external magnetic field B_{EX} is applied to the entire quantum bit array chip, the magnetic field strength of the computing area is B_{L}+B_{EX}, and the magnetic field strength of the memory area is B_{EX}.

In this way, by making a difference in magnetic field strength between the computing area and the memory area, a frequency f_{S} of precession of electrons in the quantum dots in the computing area is set to 20.01 GHz, and the frequency of precession of electrons in the quantum dots in the memory area is set to 20 GHz.

When the entire array is irradiated with an RF signal having a frequency of 20.01 GHz, the spin is rotated only in the electrons present in the quantum dots in the computing area in which the frequency of the precession coincides with the frequency of the RF, and the quantum computing can be executed.

As another computing method, in the structure in FIGS. 27A and 27B, it is also possible to arrange electrons in the memory computing area in a normal state without applying the external magnetic field and shuttle and move only the electrons of the selected quantum bits to the computing area, thereby applying the local magnetic field B_{L} and rotating the spin S of the electrons.

The invention is not limited to the embodiments described above, and includes various modifications. For example, the embodiments described above have been described in detail to facilitate understanding of the invention, and the invention is not necessarily limited to those including all the configurations described above. A part of a configuration of a certain embodiment can be replaced with a configuration of another embodiment, and the configuration of another embodiment can be added to a configuration of a certain embodiment. A part of a configuration of each embodiment may be added to, deleted from, or replaced with another configuration.

### REFERENCE SIGNS LIST

101, 1901: quantum bit array chip (QBA)
102: quantum bit (Qubit)
103: cryogenic analog chip (CAC)
104: digital control chip (CDC)
201, 2022, 2032: quantum dot control gate (XQ, XON, XQS, YQ, YQE, YQW)
202, 2021, 2031: interaction control gate (XJ, XJN, XJS, YJ, YJW, YJE)
1000: silicon quantum computer
401: computing area
402: initialization area
403: sense area
1902: quantum bit (Qubit) array
1903a, 1903b: decoder
1904: switch control register
1905: switch matrix
1906: sense amplifier
2001, 2002, 2003, 2004, 2005: output
2101: register and switch block
DR: dilution refrigerator
C: silicon channel
PB: potential barrier
S: electron spin
MA: memory area
PA: computing area
IA: initialization area
SA: sense area
CX: X-system control circuit
CY: Y-system control circuit
CS: sense system control circuit
ML: ferromagnetic film
fS: spin precession frequency
fRF, fMW: RF signal frequency
tRF: RF signal application time
VL1, VL2, VB0, VB1: bias voltage
tRB: Rabi oscillation period
V_DAC: bias voltage
BSPT: bias pattern signal
SID: control line address
SWNO: control line voltage
BSTR: bias pattern strobe signal
SWEN: control signal enable
EXRT: computing result output (data output terminal)
DAC: digital-analog converter
CG: common gate
PH: phase

1. A quantum computer comprising:
a quantum dot array in which quantum dots are two-dimensionally arranged,
the quantum computer performing quantum computing by irradiating the quantum dot array with an electromagnetic wave, wherein
the quantum dot array is divided into a computing area for performing the quantum computing and a memory area for shuttling a quantum bit stored in the quantum dot,
the quantum computer comprises a parameter table in which a control voltage and a control time during the quantum computing in the computing area are stored for each quantum dot, and
the quantum bit is controlled in the computing area based on the parameter table.

2. The quantum computer according to claim 1, wherein
the quantum computing is performed by rearranging the quantum bits in the memory area to make the quantum bits adjacent to each other, and then shuttling the quantum bits to the computing area.

3. The quantum computer according to claim 2, wherein
the quantum dot array includes a sense area, and
a computing result of the quantum computing is output by moving the quantum bit to the sense area and reading the quantum bit.

4. The quantum computer according to claim 3, wherein
the quantum dot array is implemented by repeatedly arranging a plurality of the initialization areas, a plurality of memory areas, and a plurality of computing areas, and
computing is performed by moving the quantum bit between the plurality of the memory areas.

5. The quantum computer according to claim 4, wherein
a plurality of array control signal lines in the quantum dot array are commonly connected to a first group to a fourth group via a switch, and
periodic control voltage waveforms having a same shape are applied to the first group to the fourth group with a time difference of a certain period.

6. The quantum computer according to claim 5, wherein
a variable load capacitor for controlling a change rate of a voltage of the array control signal line is connected to a common terminal side of the switch.

7. The quantum computer according to claim 4, wherein
the quantum dot array includes
a semiconductor layer,
an insulating layer disposed on the semiconductor layer,
a plurality of first gate electrodes disposed on the insulating layer and configured to trap electrons in a predetermined spin state in the semiconductor layer by applying a voltage, and
a plurality of second gate electrodes configured to cause a current for forming a magnetic field acting on the electrons to flow in an extension direction of the first gate electrodes when changing the spin state of the electrons, the plurality of second gate electrodes being disposed adjacent to the first gate electrodes and alternately with the first gate electrodes, and
control is performed to cause a current to flow through the second gate electrodes when changing the spin state of the electrons trapped in the first gate electrodes.

8. The quantum computer according to claim 4, wherein
the quantum dot array includes
a semiconductor layer,
an insulating layer disposed on the semiconductor layer,
a plurality of first gate electrodes disposed on the insulating layer and configured to trap electrons in a predetermined spin state in the semiconductor layer by applying a voltage, and
a plurality of second gate electrodes disposed adjacent to the first gate electrodes and alternately with the first gate electrodes,
a ferromagnetic film is disposed on an upper portion of the first gate electrodes in the computing area, and
when performing the quantum computing, a frequency of spin precession of an electron in the quantum dots in the computing area is different from a frequency of spin precession of an electron in the quantum dots in the memory area.

9. A computing method using electron shuttling comprising the following steps of:
(a) rearranging quantum bits in a memory area to make the quantum bits adjacent to each other, and then shuttling the quantum bits to a computing area; and
(b) controlling the quantum bits in the computing area based on a parameter table in which a control voltage and a control time during quantum computing in the computing area are stored for each quantum dot.
